(19) United States
(12) Patent Application Publication
(10) Pub. No.: US 2015/0339321 A1
(43) Pub. Date: Nov. 26, 2015

(54) Adaptable Multimedia Display System and Method

(71) Applicants: Andrew Butler, Palo Alto, CA (US); Larry Tsai, Santa Clara, CA (US); Carey Lee, Sunnyvale, CA (US); F Brian Iannce, San Jose, CA (US); John Gilbert, Applegate, OR (US)

(72) Inventors: Andrew Butler, Palo Alto, CA (US); Larry Tsai, Santa Clara, CA (US); Carey Lee, Sunnyvale, CA (US); F Brian Iannce, San Jose, CA (US); John Gilbert, Applegate, OR (US)

(73) Assignee: Konnect Labs, Inc., Sunnyvale, CA (US)

(21) Appl. No.: 14/719,622

(22) Filed: May 22, 2015

Related U.S. Application Data
(60) Provisional application No. 62/001,880, filed on May 22, 2014.

(51) Int. Cl. G06F 17/30; G06K 9/00; G10L 17/00; H04L 29/06; H04L 29/08

(52) U.S. Cl. CPC G06F 17/30247; H04L 65/403; H04L 67/1085; G10L 17/00; G06K 9/00302; G06K 9/00288

(57) ABSTRACT

An adaptable Internet-connected multimedia display that displays photo or video streams from services such as Instagram or Facebook Photos, and that customizes the photo or video streams depending on environmental factors in its external environment.

### CROSS-REFERENCE TO RELATED APPLICATIONS

The present application takes priority from Provisional App. No. 62/001,880, filed May 22, 2014, which is herein incorporated by reference.

### BACKGROUND

1. Field of the Invention

The present invention is generally in the area of social media, and specifically relates to a system and method for displaying visual images.

2. Description of Related Art

Social media has become an increasingly popular way of sharing pictures, videos, and other graphical material. Services such as Instagram, Facebook Photos, or Twitpics, are used by users around the world to share photos and videos. Typically, those photos and videos are tagged with one or more tags to indicate their content or subject matter.

Users of these services may want to have photos from these services displayed in their home on a rotating basis. At least one photo display device exists on the market for displaying photos from these services. For example, a device may be displaying a stream of photos from a particular Instagram feed, or photos that are tagged with a particular tag.

However, such a device is not easily adaptable to different social situations. For example, a user may have their photo display device set to display mildly risque photos; if their maiden aunt comes to visit, she may be shocked. A user may wish to display a different photo stream when children are present, or when people come over for a party. While it is possible to manually adjust the settings to change what photos are displayed, a user may forget to do so, leading to embarrassment.

Such devices are also not easily adaptable to a person's moods and preferences. A person may want to see pictures of cute kittens when they are in a bad mood, for example, or see pictures of beautiful men or women when they are feeling amorous.

A need therefore exists for an adaptable Internet-connected photo display system and method that automatically adjusts what photos are displayed based on external factors in the environment.

### SUMMARY OF THE INVENTION

An object of the present invention is to display tagged content that adjusts to a person's identity, moods, social situations, and environmental conditions automatically.

Another object of the present invention is to protect children and other vulnerable people from seeing inappropriate content in a digital multimedia display system.

For purposes of the present invention, a “digital multimedia display system” is any device capable of displaying visual content, such as a digital picture frame, a television, a monitor, or any other display device. In the preferred embodiment, the device is a digital picture frame. The device may also be capable of displaying audio content.

For purposes of the present invention, an “environmental parameter” is any parameter that can be sensed with a sensing device that may affect the type of visual content that a user may prefer to be displayed. Examples of such environmental parameters include, but are not limited to, sound (including the sound of human voices), light, temperature, humidity, smoke/CO content in the air, pollen or pollutant levels, motion, presence of people, presence of smartphones, pheromone levels, odors, emotions as expressed in human faces, voices, or odors.

In the preferred embodiment of the present invention, a method of displaying tagged content from the Internet is offered that comprises sensing at least one environmental parameter in the near vicinity, looking up at least one tag associated with the at least one environmental parameter, and downloading and displaying at least one image tagged with the at least one tag. The method may also comprise blocking any images tagged with the at least one tag.

The environmental parameter may be any environmental parameter that may affect the type of visual content that someone wishes to be displayed. In an embodiment, the parameter is one of the following: light, temperature, humidity, pollen level, pollutant level, motion.

In an embodiment, the environmental parameter is a human voice. The human voice may be analyzed to determine its gender, age, social situation, mood, or identity.

In an embodiment, the human voice is analyzed to determine whether it is a child's voice. Then, the system may look up tags associated with children and display images tagged with those tags, and, in an embodiment, block any images whose tags indicate that they are unsafe for children from being displayed.

In an embodiment, the human voice is analyzed to determine the identity of a person. Then, the system may look up at least one tag associated with the person (as set in the preferences ahead of time), and either display images tagged with that at least one tag, or block images tagged with the at least one tag from being displayed, depending on the preferences.

In an embodiment, the human voice is analyzed to determine a person's gender. Then, the system may look up at least one tag associated with the gender and either display images tagged with that at least one tag, or block images tagged with the at least one tag from being displayed.

In an embodiment, the human voice is analyzed to identify a social situation that is likely to be occurring—for example, a quiet romantic conversation, a boisterous party, a children's game, and so on. Then, the system may look up at least one tag associated with the social situation and either display images tagged with that at least one tag or block images tagged with the at least one tag from being displayed.

In an embodiment, the human voice is analyzed to determine what emotion is expressed in the voice—for example, sadness, happiness, anger, sexual arousal, and so on. The system then looks up at least one tag associated with the emotion and either displays images tagged with that at least one tag or blocks images tagged with the at least one tag from being displayed.

The system may also identify a person, or identify an emotion, or both, by taking and analyzing an image of the person's face. The system then looks up at least one tag associated with the emotion or the person (or the particular emotion in the particular person), and either displays images tagged with that at least one tag or blocks images tagged with the at least one tag from being displayed.

The tags and their associations may be set by the user, pre-set by the system, or both.

The system of the present invention preferably comprises a digital multimedia display system, a communication module connected to the Internet and configured to download visual content from the Internet based on tags, an environmental sensor configured to sense at least one parameter in the environment of the digital multimedia display system, and a processor and memory, said processor and memory configured to store at least one association between a tag and a value of data from the environmental sensor, to receive data from the environmental sensor, to look up at least one tag associated with the data, to use the communication module to download at least one image associated with the at least one tag and to display that image in the digital multimedia display system.

The environmental sensor may be configured to sense environmental parameters such as light, motion, temperature, humidity, pollen or pollutant levels, smoke, or carbon monoxide, and to display alerts if any emergency conditions are detected.

In an embodiment, the environmental sensor is configured to sense the sound of at least one human voice and to analyze the sound to determine at least one of the following: the identity of a person, whether the person is an adult or a child, and whether the person is male or female.

In an embodiment, the environmental sensor is configured to sense ambient sound and to analyze the sound to determine what social situation is likely to be going on—for example, a quiet conversation, a boisterous party, children at play, and so on.

In an embodiment, the environmental sensor is configured to detect the presence of a smartphone and to identify the owner of the smartphone.

In an embodiment, the environmental sensor is configured to detect a biometric parameter, such as a face, an odor, or a retina, and to identify a person using this biometric parameter.

In an embodiment, the environmental sensor is configured to detect an emotion by analyzing the sound of a person's voice, analyzing an image of the person's face, or analyzing the odor or pheromones emanating from a person.

### LIST OF FIGURES

FIG. 1 shows a diagram of the preferred embodiment of the system of the present invention.

FIG. 2 shows a flowchart of the preferred embodiment of the method of the present invention.

### DETAILED DESCRIPTION OF THE PREFERRED EMBODIMENT

In its basic form, the present invention is a system and method for displaying tagged images based on social context or personal preference. For example, if a particular person likes pictures of puppies, the system could display pictures of puppies whenever that person is around. If a particular person likes pictures of sunsets, but only when they are feeling sad, the system could display pictures of sunsets whenever it detects that the person is in the room and feeling sad. If the system detects that a boisterous party is going on, and has a pre-set association between boisterous parties and pictures of fireworks, the system could display fireworks. The association may be pre-set by the manufacturer or set by the user.

The system could also block certain images from being displayed depending on social context or personal preference. For example, the system could prevent any adult images from being displayed when children are present. If a particular person is in the room and the person does not like cats, the system could block any images of cats from being displayed. As above, the association may be pre-set by the manufacturer or set by the user.

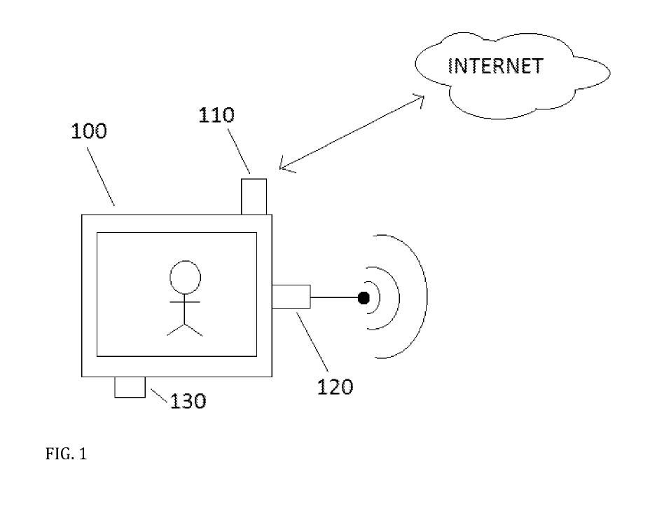

A preferred embodiment of the present invention is shown in FIG. 1. As can be seen in the figure, the system of the present invention comprises a digital multimedia display system 100, a communication module 110 connected to the Internet and configured to download visual content from the Internet based on tags, an environmental sensor 120 configured to sense at least one parameter in the environment of the digital multimedia display system 100, and a processor and memory 130, configured to store at least one tag associated with at least one value of data from the environmental sensor 120, to receive data from the environmental sensor, look up at least one tag associated with the data, use the communication module 110 to download at least one image associated with that tag or tags, and display the image in the digital multimedia display system.

In the preferred embodiment, the images are downloaded from a social media service such as Instagram, Facebook, or Twitpics. However, any other source of images or videos may also be used, as long as the images or videos are tagged with tags identifying their content or subject matter.

The digital multimedia display system is preferably a digital picture frame, but may be any other device capable of displaying visual content, possibly along with audio content, such as pictures or videos. In the preferred embodiment, the digital multimedia display system can display both video and audio content.

The communication module is preferably connected to the Internet. The Internet connection may be wired or wireless; the wireless connection may be wi-fi, Bluetooth, 3G/4G, and any other wireless Internet connection known in the art.

The environmental sensor 120 may be any sensor or sensing module that can sense data from the external environment. For example, the environmental sensor may be a light sensor, a motion sensor, a sound sensor, a temperature sensor, a humidity sensor, a sensor for pollen or pollutant levels, or a smoke/CO sensor, or any combination of the above. The environmental sensor or the processor may also comprise processing elements that enable the data received from the external environment to be interpreted. For example, if an environmental sensor receives sound data, the data may be interpreted to determine whether or not a human voice is present, whether the human voice is an adult's voice or a child's voice, what emotion the voice is showing, who the voice belongs to, and so on. If the environmental sensor receives odor or pheromone data, the data may be interpreted to identify the person emitting the odor or pheromone, or to identify the emotion the person is displaying. If the environmental sensor receives data showing that a smartphone is present in the near vicinity, the data may be interpreted to identify the owner of the smartphone. The environmental sensor may sense the user's smartphone via wi-fi, GPS, or in any other way known in the art.

The processor and memory preferably store any associations between environmental sensor data and tags. For example, a user who likes kittens may set the preferences to display any pictures tagged with #kitten whenever the user's presence is detected; a user who hates cats could set the preferences to block any images tagged with #kitten whenever the user's presence is detected. The system could be set to display images tagged with #motivation whenever an emotion of sadness or fatigue is detected, or images tagged with #sexy whenever an emotion of sexual arousal is detected. The associations may be pre-set by the manufacturer or set by the user.

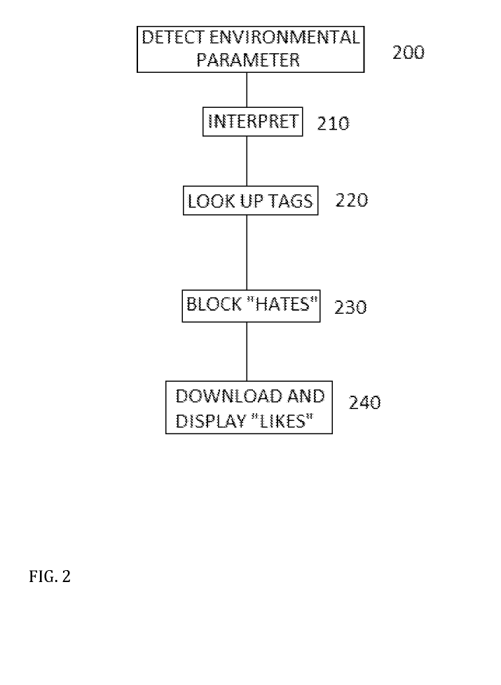

FIG. 2 shows the preferred embodiment of the method of the present invention. First, the system senses at least one environmental parameter 200 in the vicinity of the digital multimedia display system. The environmental parameter could be any variable that could affect what pictures or videos someone would want to see. For example, it could be light, temperature, humidity, pollen level, pollutant level, motion, sound, odor, images, pheromones, and so on.

The environmental parameter may also be interpreted by the system 210. For example, the sound recorded by the sensor could be interpreted to determine if any human voices are present, whether those voices belong to children or adults, whether those voices belong to men or women or both, to identify who is speaking, to determine the emotion expressed by the voices, and so on. The pheromones or odors received by the sensor could be interpreted to identify any person or people, or to determine the emotion the pheromones or odors indicate. The presence of a smartphone could be interpreted to identify the owner of the smartphone. An image received by a camera sensor could be interpreted to identify any people in the near vicinity of the system or to identify the emotion in a person's face. Other sensor data may be interpreted by the system as well, to identify people present in the room, to identify the emotions those people are likely to be experiencing, or to identify a social situation that may be going on.

The system may be used to determine what social situation may be going on. For example, the presence of many loud human voices, music, and the clinking of glasses may indicate that a party is going on. The presence of many children's voices may indicate that a children's party is going on. The presence of clinking of dishes and knives and moderately loud conversation from a few people may indicate a family dinner.

Multiple sensors may be used in the present invention. For example, the system could detect the presence of a smartphone indicating a particular user, and detect the sound of the user's voice, indicating that the user is sad. As another example, the system could detect a male and female voice having a quiet conversation, detect high pheromone levels in the air, and conclude that a romantic date is going on.

The system then looks up at least one tag associated with the environmental parameter or its interpretation 220. For example, if a particular person is identified, the system looks up any tag or tags associated with the person, as well as any tags that the person wishes to avoid or block. For example, a person may like puppies and kittens, and have the #puppy and #kitten tag set in their preferences. The system will then pull up the #puppy and #kitten tag when the person is identified as being present. If the person also hates pictures of sunsets, the system will pull up the #sunset tag.

After that, the system downloads and displays any images tagged with the tags listed as “likes” 240 and blocks any images tagged with the tags listed as “hates” 230. In the above example, the system will display any images tagged with #puppy and #kitten, while blocking any images tagged with #sunset.

If multiple people are present, their preferences may conflict. The system may have automatic priority ordering pre-set at the factory. For example, if a child and an adult are both present, the child's preference for any adult material to be blocked will be prioritized higher than the adult's preference for seeing adult material. The user may also set the priority ordering. For example, if one person is known to be phobic of spiders, and the other person likes nature photos, the phobic person's hatred of spiders will be prioritized higher than the nature lover's love of nature photos involving spiders. In an embodiment, any preference for blocking an image will automatically be set higher than the preference for seeing an image.

In another embodiment, the environmental sensing module may respond to emergency situations such as smoke, carbon monoxide, flooding, home invasion, and so on. For that embodiment, the environmental sensing module may comprise smoke sensors, carbon monoxide sensors, water sensors, burglar alarm modules, and so on. When an emergency is detected, the system may display an alert.

The user interface for the system is preferably a touchscreen; however, the system may also comprise buttons, knobs, or other controls. In an embodiment, the user interface for the system is a smartphone or multiple smartphones. For example, the user may control the system by means of an app on their smartphone. In another embodiment, the user interface for the system is a remote control.

The system may comprise additional features and modules such as wi-fi extender, cell phone signal extender, communications hub, or security camera, which add to its utility in the home.

Exemplary embodiments are described above. It will be understood that the present invention encompasses other embodiments that are obvious to a person of reasonable skill in the art, and that it is limited only by the appended claims.

1. A method of displaying tagged images from the Internet in a digital multimedia display system, comprising:
sensing at least one environmental parameter in the vicinity of the digital multimedia display system;
looking up at least one tag associated with the at least one environmental parameter;
downloading at least one image tagged with the at least one tag from the Internet;
displaying the at least one image in the digital multimedia display system.

2. The method of claim 1, further comprising:
looking up at least one second tag associated with the at least one environmental parameter;
blocking any images associated with the at least one second tag from being downloaded or displayed in the digital multimedia display system.

3. The method of claim 1, wherein the at least one environmental parameter is one of the following: light, temperature, humidity, pollen level, pollutant level, motion.

4. The method of claim 1, wherein the at least one environmental parameter is the sound of at least one human voice.

5. The method of claim 4, further comprising:
analyzing the sound of the at least one human voice;
determining whether at least one human voice is a child's voice;
performing at least one of the following steps:
looking up at least one tag associated with children, downloading at least one image associating with the at least one tag, and displaying the at least one image in the digital multimedia display system;
blocking any images from being displayed whose tags indicate they are unsafe for children.

6. The method of claim 4, further comprising:
analyzing the sound of the at least one human voice;
identifying at least one person;
looking up at least one tag associated with the at least one person;
performing one of the following group of steps:
downloading at least one image associated with the at least one tag from the Internet and displaying the at least one image in the digital multimedia display system;
blocking any images associated with the at least one tag from being downloaded or displayed.

7. The method of claim 4, further comprising:
analyzing the sound of the at least one human voice;
identifying the gender of a person;
looking up at least one tag associated with the gender;
performing one of the following group of steps:
downloading at least one image associated with the at least one tag from the Internet and displaying the at least one image in the digital multimedia display system;
blocking any images associated with the at least one tag from being downloaded or displayed.

8. The method of claim 4, further comprising:
analyzing the sound of the at least one human voice;
identifying a social situation;
looking up at least one tag associated with the social situation;
performing one of the following group of steps:
downloading at least one image associated with the at least one tag from the Internet and displaying the at least one image in the digital multimedia display system;
blocking any images associated with the at least one tag from being downloaded or displayed.

9. The method of claim 4, further comprising:
analyzing the sound of the at least one human voice;
identifying an emotion;
looking up at least one tag associated with the emotion;
performing one of the following group of steps:
downloading at least one image associated with the at least one tag from the Internet and displaying the at least one image in the digital multimedia display system;
blocking any images associated with the at least one tag from being downloaded or displayed.

10. The method of claim 1, where the environmental parameter is a person's face, where the step of looking up at least one tag comprises:
identifying the person;
looking up at least one tag associated with the person.

11. The method of claim 1, where the environmental parameter is a person's face, where the step of looking up at least one tag comprises:
identifying an emotion by analyzing an image of the person's face;
looking up at least one tag associated with the emotion.

12. The method of claim 1, where the environmental parameter is the presence of a smartphone owned by a person, where the step of looking up at least one tag comprises:
identifying the person;
looking up at least one tag associated with the person.

13. The method of claim 1, where the environmental parameter is the presence of a first smartphone owned by a first person and a second smartphone owned by a second person, where the step of looking up at least one tag comprises:
identifying the first person;
identifying the second person;
looking up at least one tag associated with the first person;
looking up at least one tag associated with the second person;
determining which tag to prioritize.

14. The method of claim 13, wherein the step of determining which tag to prioritize comprises:
blocking any tags that the first person wishes to be blocked;
blocking any tags that the second person wishes to be blocked;
displaying any tags the first person wishes to be displayed, except for any blocked tags;
displaying any tags the second person wishes to be displayed, except for any blocked tags.

15. The method of claim 1, further comprising:
setting at least one tag to be associated with an environmental parameter.

16. A system for displaying tagged visual content, comprising:
a digital multimedia display system;
a user interface;
a communication module connected to the Internet, said communication module configured to download visual content from the Internet based on tags;
an environmental sensor, said environmental sensor configured to sense at least one parameter in the environment of the digital multimedia display system;
a processor and memory, said processor and memory configured to:
store at least one tag associated with at least one value of data from the environmental sensor;
receive data from the environmental sensor;
look up at least one tag associated with the data;
use the communication module to download at least one image associated with the at least one tag;
display the image in the digital multimedia display system.

17. The system of claim 16, wherein the environmental sensor is configured to sense one of the following: light, motion, temperature, humidity, pollen levels, pollutant levels, smoke, carbon monoxide.

18. The system of claim 16, wherein the environmental sensor is configured to:
sense the sound of at least one human voice;
analyze the sound to determine at least one of the following: the identity of a person, whether the person is an adult or a child, whether the person is male or female.

19. The system of claim 16, wherein the environmental sensor is configured to:
sense ambient sound;
analyze the sound to determine a social situation that is likely to be going on.

20. The system of claim 16, wherein the environmental sensor is configured to:
detect the presence of a smartphone;
identify the owner of the smartphone.

21. The system of claim 16, wherein the environmental sensor is configured to:
detect a biometric parameter, said biometric parameter being one of the following:
a face, an odor, a retina;
identify a person using the biometric parameter.

22. The system of claim 16, wherein the environmental sensor is configured to detect an emotion by performing one of the following:
analyzing the sound of a person's voice;
analyzing an image of a person's face;
analyzing the odor of a person;
analyzing the pheromones emanating from a person.
